(19) United States
(12) Patent Application Publication
(10) Pub. No.: US 2002/0100992 A1
(43) Pub. Date: Aug. 1, 2002

(54) Method for operating an injection unit for an injection molding machine

(75) Inventor: Harald Bleier, Wiener Neustadt (AT)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Battenfeld Service GmbH, Meinerzhagen (DE)

(21) Appl. No.: 10/025,953

(22) Filed: Dec. 20, 2001

Related U.S. Application Data
(63) Continuation-in-part of application No. 09/999,174, filed on Nov. 30, 2001.

(30) Foreign Application Priority Data
Dec. 2, 2000 (DE) 100 60 086.7

(51) Int. Cl. B29C 45/76; B29C 45/77

(52) U.S. Cl. 264/40.1; 264/40.3

(57) ABSTRACT

A method is provided for operating an injection unit of an injection molding machine for metering or injecting material, also to create a back pressure in the melt, or to create a holding pressure on the melt, by means of a screw drive including two electric motors, with a controlled electrical connection to one another, and by means of a spindle-nut combination, such that the two electric motors can be operated in the same direction of rotation or in the opposite direction of rotation. In one embodiment, the two electric motors are operated counter-rotationally to inject the material, or the two electric motors are operated synchronously in their direction of rotation to create a back pressure in the melt or a holding pressure on the melt, a difference rpm being set by means of at least one electric feedback signal.

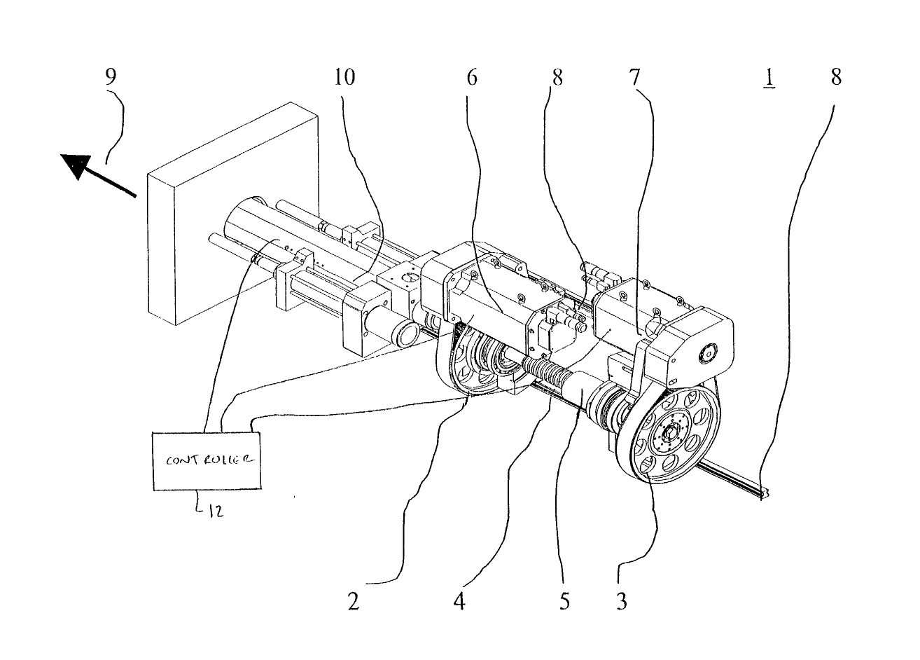

### RELATED APPLICATIONS

This application is a continuation-in-part of U.S. application Ser. No. 09/999,174, filed Nov. 30, 2001, which claims priority to German Application 100 60 086.7, filed Dec. 2, 2000, the entire teachings of which are incorporated herein by reference.

### BACKGROUND OF THE INVENTION

Methods of operating an injection molding machine are generally known. To produce a part from thermoplastic material, granulated plastic is plasticized in an injection molding machine, is metered into the space in front of the screw, and a back pressure is built up in the melt. Usually, the melt is injected into a tool cavity by moving the screw axially. The melt pressure is maintained, that is a holding pressure is built up, so as to compensate the natural material shrinkage. For example, EP 662 382 describes an injection unit which is operated by electric motors and which likewise operates by the injection molding process described above. However, here the back pressure in the melt is created by an additional hydraulic apparatus.

A disadvantage of the known methods used by these electric injection molding machines is that an independent hydraulic system, among other things, is used to create and control the back pressure. Because of its complexity, such a system can be very costly. The use of an electric direct drive, where the nut is an integral component of the motor, is a source of disadvantages for this system, as regards cooling, maintenance (lubrication), and service. The motor (metering motor) is held fixed in its position (rpm 0) during injection and during the holding pressure. This results in a relatively high current load on the electronic power sections as long as the injection process lasts. This can raise the temperature above permissible limits, unless the current is reduced early on. This circumstance greatly reduces the capability of this machine in elastomer applications, where extremely long injection and holding pressure times are required.

### SUMMARY OF THE INVENTION

In accordance with one aspect of the invention, a method is provided for operating an injection unit through two electric motors, which are capable of all required injection processes, requires no additional hydraulic equipment, and excludes overload of the motors or of their electric components.

In one embodiment, the two electric motors, which can be servomotors, are operated counter-rotationally to inject material, or the two electric motors are operated synchronously in their direction of rotation to create a back pressure in the melt or a holding pressure on the melt, a difference rpm being set by means of at least one electric feedback signal, to coordinate the two motors with one another. If the losses, e.g., friction, are the same, the difference rpm is equal to zero (0). The material can include thermoplastic, wax, thermoset, and elastomer materials.

The counter-rotation of the two electric motors sets the spindle-nut combination in action, and the relative motion of the spindle to the nut moves the screw axially. The injection rate can be controlled and/or regulated through the difference between the rotational speeds of the two motors. The greater this difference, the greater is the axial advance and thus the injection rate. If the two electric motors are operated in synchronous rotation, that is without any relative motion between the spindle and the nut, the screw is not moved axially. However, since the screw continues to rotate, material continues to be transported now as before, and thus a back pressure is created in the melt in the space before the screw, such as is needed for metering, or a holding pressure is exerted on the melt in the cavity. If a difference rpm is needed, this is set through the electric feedback signal. This assures that the screw executes an axial motion, for example, during the metering process. Through these feedback signals, one can likewise cause each process step to proceed according to a predetermined profile. For example, this could be an increase of holding pressure as a function of cooling time, but other regulatory profiles are also conceivable here.

Feedback signals can include pressure, speed, or acceleration. As pressure one can use, for example, the melt pressure in the preplasticizing cylinder, which is measured directly or indirectly by a load cell. A combination of the above feedback signals can be also used to obtain an optimal production result which is reproducible from cycle to cycle.

According to another embodiment of the invention, a linear-path measuring system furnishes an additional feedback signal. For example, the position of the screws is measured in this way. This has the special advantage that it is no longer necessary to determine a zero point, that is to make a reference measurement, before the process actually begins, since the relative changes are measured, and the absolute magnitudes are no longer necessary.

In a particular embodiment, the feedback signal or signals are processed by at least one programmable control.

Another embodiment specifies that, when the material is being metered, the two electric motors rotate in the opposite direction as when a holding pressure is exerted on the melt. As already described above, there is no axial motion of the screw while the melt is being metered and while the holding pressure is applied to the melt, as long as no difference rpm between the two electric motors is produced by a feedback signal. However, the rotation of the screw furthermore assures that the electric components of the electric motors are protected against overload. Greater forces or torques are needed to produce a holding pressure on the melt; in electric injection molding machines, these are produced by high currents. If this happens while the motors are standing still, this will cause ohmic losses, which again are converted into heat. Elevated temperatures of the components, especially of the transistors, damage them and consequently shortens the lifetime of the machine. However, if the desired effect—no axial motion of the screw—is achieved even though the motors are rotating, as in one embodiment of the invention, the force or the torque produced by the current can be converted into rotational motion, and an undesirable rise of temperature does not occur. The bonding thus is not subjected to stress from thermal cycles.

The method can also include a reversal of the direction of rotation of the screw during the injection process relative to the direction of rotation of the screw during the metering process. This achieves the result that, especially during the holding pressure, no material is transported in the plasticizing direction, which could cause the material to stay in the plasticizing cylinder too long and thus be thermally damaged. On the contrary, the material in the screw channels is transported backward.

Another embodiment specifies that at least one electric signal is emitted to actuate a switchable element between the screw and the spindle-nut combination. The switchable element can be, for example, a coupling which prevents the screw from turning after the metering process, since the transmission of torque can be prevented. The problem of thermally stressing the motor components is obviated, since these components can continue to rotate.

### BRIEF DESCRIPTION OF THE DRAWING

The foregoing and other objects, features and advantages of the invention will be apparent from the following more particular description of preferred embodiments of the invention, as illustrated in the accompanying drawing. The drawing is not necessarily to scale, emphasis instead being placed upon illustrating the principles of the invention.

The FIGURE is a perspective view of one embodiment of an injection unit in accordance with the present invention.

### DETAILED DESCRIPTION OF THE INVENTION

The drawing shows an embodiment of the invention. The FIGURE shows an injection unit 1 to operate a plasticizing and injection screw with housing 10. In one embodiment, the housing 10 is heated to plasticize, i.e., melt, material which can include thermoplastic, wax, thermoset, and elastomer materials. The screw is turned through the belt pulley 2, by means of a toothed belt, in conjunction with the motor 6. A spindle 4, which is connected to a spindle nut 5, is situated at the belt pulley 2. The spindle nut 5 again is situated at a belt pulley 3 which is driven by the motor 7, through a toothed belt. Motors 6 and 7 include servomotors in one embodiment. To prevent the screw from moving axially, it is now necessary to balance out the turning of the spindle 4, driven by the belt pulley 2, through the concomitant turning of the spindle nut 5. This is possible if the rotational speeds of the motors 6 and 7 are exactly coordinated by a programmable controller 12, which is connected to the screw, and motors 6 and 7. The screw can move axially if there is an rpm difference between the two motors 6 and 7. The spindle-nut combination 4, 5 goes into action, the distance between the belt pulleys 2 and 3 decreases, and thus moves the screw axially in the plasticizing direction 9. The injection unit is supported by a plate member, which is not shown; the motor/belt pulley combination runs along guide 8.

An injection unit can be implemented herein as disclosed in U.S. application Ser. No. 09/998,917 (Attorney's Docket No. 1959.2013-000 (KP 041 US)), which claims priority to German Application 100 60 087.5 filed on Dec. 2, 2000, filed on even date herewith, the teachings of which are incorporated herein in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for operating an injection unit of an injection molding machine for metering or injecting a material, which has been melted to create a back pressure in the melt, or to create a holding pressure on the melt, by means of a screw drive including two electric motors, with a controlled electrical connection to one another, and by means of a spindle-nut combination, such that the two electric motors can be operated in the same direction of rotation or in the opposite direction of rotation, and can be operated at the same or different rotational speed, the two electric motors being operated to inject the material, or the two electric motors being operated to create a back pressure in the melt or a holding pressure on the melt.

2. The method of claim 1, wherein a different rpm between the two electric motors is set by at least one feedback signal.

3. The method of claim 2, wherein a pressure, a speed, or an acceleration is used as the feedback signal.

4. The method of claim 3, wherein a linear-path measuring system furnishes an additional feedback signal.

5. The method of claim 3, wherein the feedback signal is processed by at least one programmable control.

6. The method of claim 1, wherein when the material is being metered, the two electric motors rotate in the opposite direction as when a holding pressure is exerted on the melt.

7. The method of claim 1, wherein during the injection process, the screw rotates in the opposite direction as it does during the metering process.

8. The method of claim 1, wherein at least one electric signal is emitted to actuate a switchable element between the screw and the spindle-nut combination.

9. The method of claim 1, wherein the motors include servomotors.

10. The method of claim 1, wherein the two motors are operated counter-rotationally to inject the material.

11. The method of claim 1, wherein the two motors are operated synchronously in their direction of rotation to create a back pressure in the melt or a holding pressure on the melt.

12. The method of claim 1, wherein the material includes a thermoplastic material.

13. A method for operating an injection unit for an injection molding machine that processes a material, comprising:
plasticizing the material with a screw of the injection unit;
rotating the screw with at least one of a first motor and a second motor; and
moving the screw axially with at least one of two motors which are controlled by a controller using a feedback signal.

14. The method of claim 13, further comprising rotating the motors in an opposite direction.

15. The method of claim 13, further comprising rotating the motors in the same direction.

16. The method of claim 13, wherein the material includes a thermoplastic material.

17. A method for operating an injection unit for an injection molding machine that processes a material, comprising:
transporting and metering the material with a screw of the injection unit;
rotating the screw with at least one of a first motor and a second motor; and
moving the screw axially with at least one of the two motors which are controlled by a controller using a feedback signal.
